(19) United States
(12) Patent Application Publication
(10) Pub. No.: US 2016/0001457 A1
(43) Pub. Date: Jan. 7, 2016

(54) Sheet Material Cutting Device Using a Wire Pinched Between Two Rollers

(71) Applicant: Arthur Donald Shapiro, Winnipeg (CA)

(72) Inventor: Arthur Donald Shapiro, Winnipeg (CA)

(21) Appl. No.: 14/322,412

(22) Filed: Jul. 2, 2014

(51) Int. Cl. B26D 7/20; B26D 7/14; B26D 7/01

(52) U.S. Cl. CPC B26D 7/204; B26D 7/015; B26D 7/14

(57) ABSTRACT

A sheet material primarily fabric is cut by providing a substantially cylindrical wire defining a cutting line lying between a top roller and a bottom roller mounted on a carriage arranged to run along the wire with the wire located in a nip of the rollers. The fabric is laid over the wire on a support surface and the carriage is driven along the wire so that the peripheral surface of the top roller applies pressure on the fabric between the roller surface and the wire. The fabric is thus compressed between the top roller surface and the wire in a pinching action which causes the wire to engage into and effect cutting of the fabric along the cutting line. The two rollers rotate by their engagement with the fabric and wire and smoothly roll over the fabric without bunching.

This invention relates to an apparatus for the cutting of sheet material such as fabric where the sheet material is cut using a wire pinched between two rollers

### BACKGROUND OF THE INVENTION

The apparatus and method can be used for cutting sheet materials but is primarily designed for the cutting of fabric. Sheet material such as plastics materials can readily be slit simply by a stationary blade. The cutting of fabric with fibers in various directions including non-woven, knitted and woven fabrics is more difficult since the fibers can catch onto a blade and thus be pulled interfering with the cutting action and possibly damaging the fabric. It is necessary therefore to provide regularly sharpened blades for the cutting action when cutting fabric containing fibers of this type. Generally a cutting action is effected using a disc shaped blade with a sharpened outer edge which is driven in rotation as the blade is moved across the sheet of fabric to be cut. This arrangement is relatively complex, requires relatively complex sharpening devices for maintaining the blade sharpened and also requires regular replacement of the blade since the sharpening action tends to wear the blade to a condition when it can no longer be used. The blades themselves are relatively expensive.

### SUMMARY OF THE INVENTION

It is one object of the present invention, therefore, to provide an improved apparatus for cutting sheet material such as fabric which avoids the use of knives which require regular maintenance and sharpening

According to a first aspect of the invention there is provided an apparatus for cutting sheet material comprising:

a material support surface arranged for receiving the sheet material laid on the material support surface;

a substantially cylindrical wire defining a cutting line lying across the material support surface;

a carriage movable across the material support surface along the wire;

a top roller mounted on the carriage having a peripheral roller surface, the top roller having an axis transverse to the wire so that the peripheral roller surface of the top roller rolls along the wire;

a bottom roller mounted on the carriage having a peripheral roller surface, the bottom roller having an axis transverse to the wire and parallel to the axis of the top roller so that the peripheral roller surface of the bottom roller rolls along the wire;

the top and bottom rollers being arranged to pinch the wire at a nip therebetween;

a spring pressure arrangement for applying a pressure between the top and bottom rollers with the wire therebetween;

the carriage with the top and bottom rollers carried thereon being movable along the wire with the sheet material laid over the wire such that the peripheral roller surfaces are moved in a direction of rolling movement along the wire while the rollers rotate about the axis generally at a right angle to the direction of rolling movement;

the pressure between the peripheral roller surfaces and the wire being arranged compress the sheet material between the top roller and the wire;

the top and bottom roller surfaces being wider than the wire such that the peripheral roller surfaces apply a pressure to the sheet material pressing the sheet material onto the wire to form a pinching action of the sheet material on the wire;

and the wire being arranged such that the pinching action causes the wire to engage into and effect cutting of the sheet material along the cutting line.

Preferably the top roller is spring biased toward the wire by a spring mounted on the carriage.

Preferably the bottom roller has a smaller diameter than the top roller.

Preferably the bottom roller has a small diameter so as to be carried on the carriage between the wire and the material support surface.

Preferably the top and bottom rollers are freely rotatable so as to be driven by rolling movement along the sheet material and the wire. Although they can be driven in some embodiments with a drive system for the carriage.

Preferably the carriage includes a guide surface over which the sheet material slides as the carriage moves forwardly.

Preferably the guide surface includes a front portion in front of the rollers with a guide slot within which the wire extends.

Preferably the front portion is arched from a front tip which is below the wire upwardly to a height above the wire so as to lift the sheet material in front of the nip between the top and bottom rollers.

Preferably the front portion is arranged so as to lift the sheet material into engagement with the top roller.

Preferably there is provided a guide track for guiding movement of the carriage.

In one arrangement the carriage is moved by a manually operable push rod which is hinged to a rear end of the carriage.

### BRIEF DESCRIPTION OF THE DRAWINGS

One embodiment of the invention will now be described in conjunction with the accompanying drawings in which:

FIG. 1 is a side elevational view of an apparatus for cutting fabric according to the present invention.

FIG. 2 is a top plan view of the apparatus of FIG. 1.

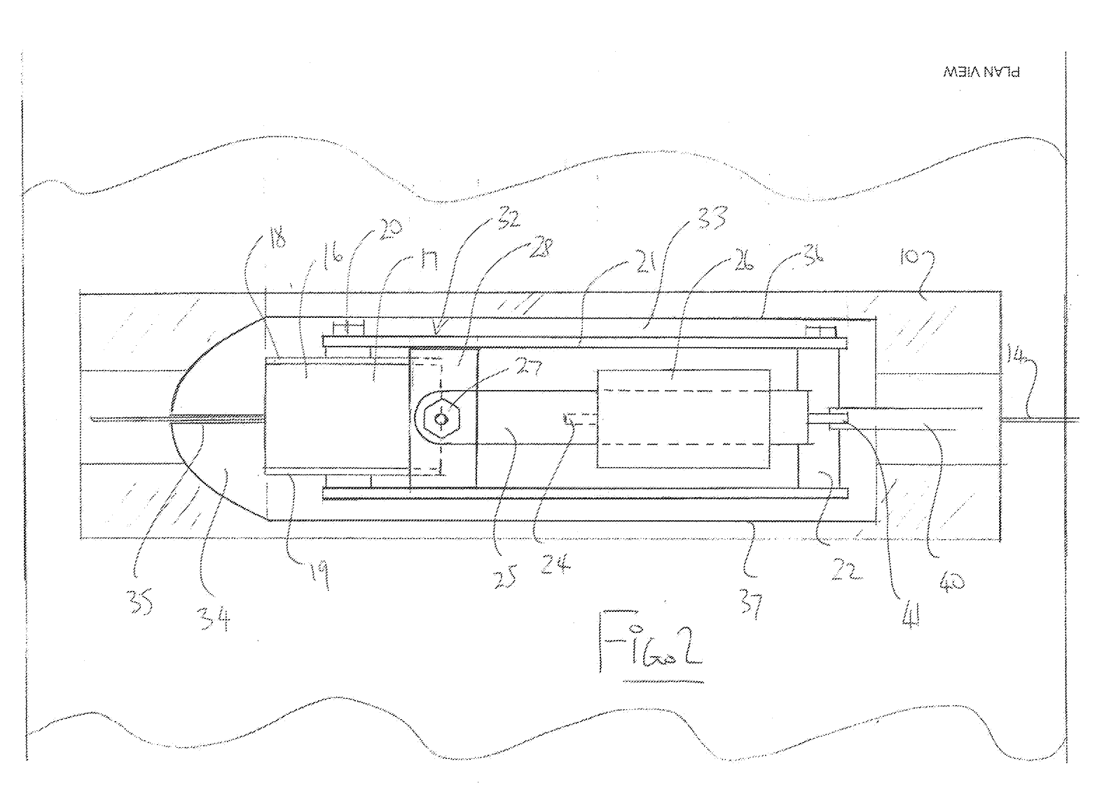

FIG. 3 is a cross-sectional view along the lines 3-3 of the apparatus of FIG. 1 on an enlarged scale.

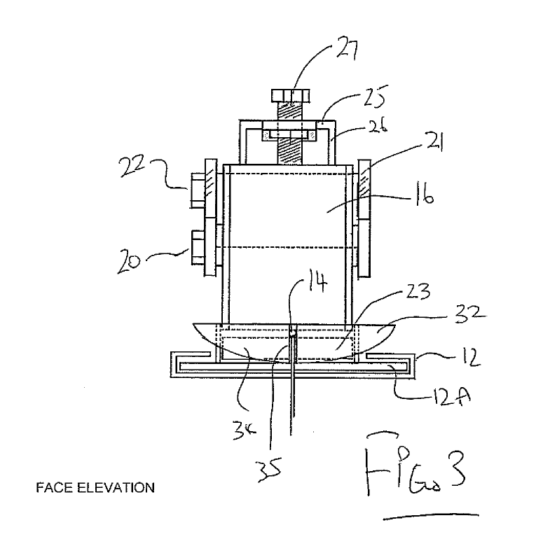

FIG. 4 is a cross-sectional view across the roller and wire of the apparatus on a further enlarged scale showing the cutting action.

### DETAILED DESCRIPTION

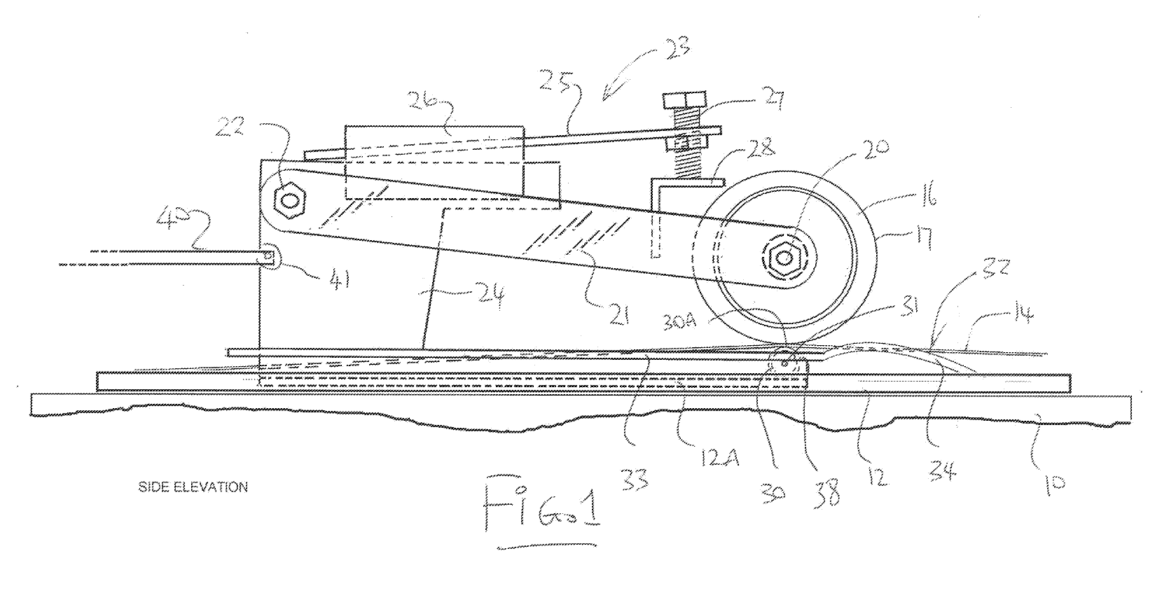

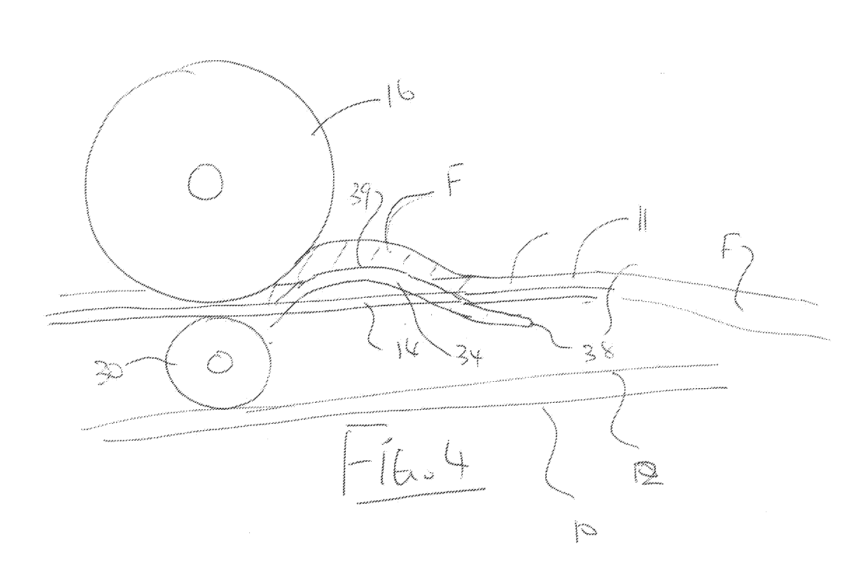

An apparatus and method for cutting a sheet of fabric is shown in the Figures and comprises a fabric table 10 over which a fabric 11 (not shown in FIG. 1 but in FIG. 4) to be cut is laid so that the fabric is stationary on the horizontal table and laid out ready for cutting.

Across the table is mounted an elongate guide track 12 in the form of a C-shaped member 12 within which a plate 12A slides across the table 10. On top of the horizontal top surface 10 is attached a wire 14 which extends along a center line of the top surface 10, thus forming a cutting line, and is attached at each end of the beam track 12 by suitable clamping devices (not shown). The wire 14 is thus held at tension and straight across the width of the table.

The wire is a simple metal wire preferably formed of steel which has a smooth cylindrical outer surface. Tempered steel is preferred to mild steel as mild steel is more compressible and thus will lose its cylindrical shape more quickly. An example of a suitable wire is tempered or semi-tempered piano wire. The diameter of the wire is selected to be as small as possible bearing in mind that the diameter must be significantly greater than the compressed thickness of the fabric otherwise the fabric will flood the wire on either side of the wire and little cutting effect will occur. A small diameter reduces the width of the surface contacting the fabric and therefore increases the pressure on the fabric at the cut line. The diameter of the wire is therefore preferably in the range 1/32 to 1/64 inch.

The apparatus further includes a top roller 16 which is arranged to roll along the length of the wire 14. The roller has an outer peripheral surface 17 which is cylindrical in shape and thus defines at the point of contact a horizontal contact surface portion which is wider than the wire and extends to side edges 18 and 19 of the roller. The surface 17 may be slightly crowned but its curvature is less than that of the wire so that it presents in effect a wider surface than the wire to the fabric 11.

The roller 16 is carried on a shaft 20 which defines an axis of rotation of the roller which is at right angles to the wire and spaced above the wire.

The roller 16 is mounted on the shaft on suitable bearings which allow the peripheral surface 17 to rotate relative to the shaft while the shaft is held stationary. The shaft is carried in a yoke 21 defined by a pair of side legs connecting to a support coupling 22.

The roller and the coupling 22 are mounted on a carriage 23 which slides across the table 10 at the guide track 12. The carriage 23 includes a center vertical post 24 attached to the guide plate 12A and standing vertically upwardly therefrom in a plane parallel to the wire 14 so that the fabric when cut can pass either side of the center support post 24. The coupling 22 is carried on an upper part of the post 24.

The yoke 21 carrying the roller 16 is spring biased downwardly by a spring plate 25 carried by a mounting 26 on the top of the post 24 so as to apply downward pressure from the roller peripheral surface 27. This pressure is adjustable by a screw 27 at the spring plate 25 by pressing on the flange 28 bridging the yoke 21.

The carriage 23 further carries a bottom roller 30 mounted underneath the wire 14 with an axle 31 defining an axis of rotation parallel to that of the top roller at the axle 20.

A fabric guide plate 32 is mounted on the carriage 23 for movement with the rollers 16 and 30. The guide plate includes a rear portion 33 behind the nip of the rollers and a front nose portion 34. The plate has side edges 36 and 37 located outwardly of the sides of the rollers. The nose portion has a center slot 35 along which the wire 14 extends. The bottom roller is located in an opening 38 in the plate so as tp project upwardly into nipping action with the top roller with the wire 14 therebetween.

The apparatus thus comprises the material support surface 10 for receiving the sheet material laid on the material support surface with the substantially cylindrical wire 14 defining a cutting line lying across the material support surface 10.

The carriage 23 is movable across the material support surface along the wire with the top roller 16 mounted on the carriage having a peripheral roller surface 17 and rolls along the wire.

The bottom roller 30 is also mounted on the carriage 23 with a peripheral roller surface 30A which rolls along the bottom of the wire with the top and bottom rollers being arranged to pinch the wire at the nip therebetween. The spring 25 applies a spring pressure arrangement between the top and bottom rollers with the wire therebetween to pinch the fabric.

As shown in FIG. 4, the carriage with the top and bottom rollers carried thereon is driven or pushed along the wire with the fabric laid over the wire such that the peripheral roller surfaces are moved in a direction of rolling movement along the wire while the rollers rotate about the axis generally at a right angle to the direction of rolling movement. The pressure between the peripheral roller surfaces and the wire compress the fabric between the top roller and the wire. As the top and bottom roller surfaces are wider than the wire, the peripheral roller surfaces apply a pressure to the fabric pressing the sheet material onto the wire to form a pinching action of the fabric on the wire. The wire is arranged such that the pinching action causes the wire to engage into and effect cutting of the fabric along the cutting line.

The bottom roller has a smaller diameter than the top roller and has a diameter so as to be carried on the carriage between the wire 14 and the material support surface 10. The top and bottom rollers are freely rotatable so as to be driven by rolling movement along the fabric and the wire.

The guide surface 32 over which the fabric slides as the carriage moves forwardly includes the front portion 34 in front of the rollers 16, 30 with the guide slot 35 within which the wire extends is arched from a front tip 38 which is below the wire upwardly to a height at an uppermost portion 39 above the wire so as to lift the fabric F in front of the nip between the top and bottom rollers and into engagement with the top roller so that the fabric is guided into the nip and grasped between the rollers to is reduce or prevent bunching.

The carriage can moved by a drive motor system connected between the carriage and the support or in a manual simple system can be operated by a manually operable push rod 40 hinged at 41 to a rear end of the carriage 23.

In operation, the carriage 23 is moved to one end of the bar 12 at a position spaced from the area to receive the fabric. The fabric is then pulled across the table and laid over the bar with the intended cut line of the fabric located directly on top of the wire. The carriage is then moved so that the rollers run along the wire until the rollers encounters the fabric. At this point the rollers run up on top of the fabric and apply pressure onto the fabric thus pinching the fabric between the peripheral surface 17 of the roller and the top surface of the wire while the fabric is lifted by the bottom roller.

The wire is of circular cylindrical shape so that its area so that it contacts the fabric at an area which is smoothly curved and preferably arcuate. In this area there is no cutting edge and no sharpened knife edge.

Both the roller and the wire have outside surfaces manufactured of materials which are sufficiently rigid or hard so that they do not deform but instead simply effect a pinching action on the fabric. The amount of spring pressure is selected so that the pinching action is sufficient to sever the fabric at the point of maximum contact between the roller and the wire. This point of maximum contact is relatively small since the roller is curved in one direction and the wire is curved in the opposite direction thus concentrating all of the forces at the very small area of contact therebetween. These forces are sufficient in practice to sever the fabric by the pinching action.

Fabric of various different types can be severed in this manner and in commercially available type fabrics used for clothing, the system is suitable for severing fine silk up to relatively heavy denim of the order of 14 ounce denim.

The cutting action occurs without any severing by knife blade so that there is no danger of the fibers of the fabric being caught on burrs on the blade and pulled.

Provided the wire retains its cylindrical shape and provided the roller avoids the formation of a groove, the point of contact is maintained sufficiently small to effect the severing action. Even when the wire begins to deform and the roller begins to form a groove, replacement of these items is relatively inexpensive since they are commercially available and non-specialized items.

The rollers can simply be formed by commercial bearings which are “off the shelf” and inexpensive. The outer race of the bearing is hard enough to carry out the cutting function. Little wear occurs on the bearing's surface. The wire is typically is not as hard as some tempered wires and does flatten after long periods of cutting. I chose it for the proper thickness and it's readily available and inexpensive.

In a possible modification suitable for more sophisticated machinery (not shown) the wire can be supplied by winding and unwinding spools of wire for the giving the cutting mechanism months of use before requiring servicing.

1. Apparatus for cutting sheet material comprising:
a material support surface arranged for receiving the sheet material laid on the material support surface;
a substantially cylindrical wire defining a cutting line lying across the material support surface;
a carriage movable across the material support surface along the wire;
a top roller mounted on the carriage having a peripheral roller surface, the top roller having an axis transverse to the wire so that the peripheral roller surface of the top roller rolls along the wire;
a bottom roller mounted on the carriage having a peripheral roller surface, the bottom roller having an axis transverse to the wire and parallel to the axis of the top roller so that the peripheral roller surface of the bottom roller rolls along the wire;
the top and bottom rollers being arranged to pinch the wire at a nip therebetween;
a spring pressure arrangement for applying a pressure between the top and bottom rollers with the wire therebetween;
the carriage with the top and bottom rollers carried thereon being movable along the wire with the sheet material laid over the wire such that the peripheral roller surfaces are moved in a direction of rolling movement along the wire while the rollers rotate about the axis generally at a right angle to the direction of rolling movement;
the pressure between the peripheral roller surfaces and the wire being arranged compress the sheet material between the top roller and the wire;
the top and bottom roller surfaces being wider than the wire such that the peripheral roller surfaces apply a pressure to the sheet material pressing the sheet material onto the wire to form a pinching action of the sheet material on the wire;
and the wire being arranged such that the pinching action causes the wire to engage into and effect cutting of the sheet material along the cutting line.

2. The apparatus according to claim 1 wherein the top roller is spring biased toward the wire by a spring mounted on the carriage.

3. The apparatus according to claim 1 wherein the bottom roller has a smaller diameter than the top roller.

4. The apparatus according to claim 1 wherein the bottom roller has a diameter so as to be carried on the carriage between the wire and the material support surface.

5. The apparatus according to claim 1 wherein the top and bottom rollers are freely rotatable so as to be driven by rolling movement along the sheet material and the wire.

6. The apparatus according to claim 1 wherein the carriage includes a guide surface over which the sheet material slides as the carriage moves forwardly.

7. The apparatus according to claim 6 wherein the guide surface includes a front portion in front of the rollers with a guide slot within which the wire extends.

8. The apparatus according to claim 7 wherein the front portion is arched from a front tip which is below the wire upwardly to a height above the wire so as to lift the sheet material in front of the nip between the top and bottom rollers.

9. The apparatus according to claim 7 wherein the front portion is arranged so as to lift the sheet material into engagement with the top roller.

10. The apparatus according to claim 1 wherein there is provided a guide track for guiding movement of the carriage.

11. The apparatus according to claim 1 wherein the carriage is moved by a manually operable push rod.

12. The apparatus according to claim 11 wherein the push rod is hinged to a rear end of the carriage.
